(19) United States
(12) Patent Application Publication
(10) Pub. No.: US 2006/0089870 A1
(43) Pub. Date: Apr. 27, 2006

(54) Intelligent and time varying out of home information or advertising system

(76) Inventor: Gunnar Myhr, Jar (NO)

Correspondence Address: William B Patterson;Moser Patterson & Sheridan, 3040 Post Oak Boulevard, Suite 1500, Houston, TX, 77056, US

(21) Appl. No.: 10/526,701

(22) PCT Filed: Sep. 4, 2003
(86) PCT No.: PCT/NO03/00308

§ 371 Date: Sep. 6, 2005

(30) Foreign Application Priority Data
Sep. 4, 2002 (NO) 20024224

(51) Int. Cl. G06Q 30/00

(52) U.S. Cl. 705/14

(57) ABSTRACT

An integrated advertising or messaging system that may target various socio-economic groups, as a function of time, weekday, traffic conditions and weather is provided. The system may offer real time interactions with receivers, to provide additional information or the ordering of goods or services. The concept yields optimising and cost effective solutions to the communication between transmitter (advertiser) and receiver (consumer).

### INTRODUCTION

The present invention relates to the field of out of home information and advertisement presentation by means of display boards or sites with variable and controllable information content. More precisely, the invention concerns an information display system and a method for operating at least one information display unit. At least one control unit controls duration of, and selection between, various still picture and video messages being displayed by the display units.

### BACKGROUND AND PRIOR ART

The traditional “Out of home advertising market” can be divided into the following three segments:

Street Furniture Overview, which is the youngest and fastest growing sector. It was originally developed for local authorities in applications or locations like bus shelters or free standing panels. Later it was expanded into private sector locations like shopping malls and supermarkets.

Billboard Overview is the traditional outdoor product, and at the same time represents the greatest outdoor advertising sector. Typical products are seven to fourteen days campaigns for short dated regional and national campaigns, and long term campaigns of up to one year for local advertising.

Transport Overview, transport posters have been used since the late 19th century, in the form of advertising on or in buses, trains, trams, railway stations and airports, or free standing panels or billboards installed in areas with significant passenger traffic.

The outdoor advertising market share of the global advertising market continues to grow, reflecting the increasing benefit of the medium, which is characterised by high volumes at low cost per thousand (CPT). Key markets like Europe and the US have annual growth rates of approximately 10%. The total market size for the outdoor advertising market in the US is represented by 396.000 traditional billboard faces, 33.000 backlighted bus passenger shelter advertisements, back lighted displays in 1.200 shopping malls, advertisements on 37.600 buses and 13.000 fixed rail cars (Outdoor Services, Inc., 1998).

In e.g. Germany there are about 220.000 outdoor advertising sites, according to industry sources. The largest board is the “CITY Lights Grossfläche” (3.56 m×2.52 m=9.0 m²), of which there are approximately 5.000 units. In addition, there are about 80.000 smaller boards (1.19 m×1.68 m=2.0 m²), the so called “CITY Lights”.

Large multicolour flat panel displays based on e.g. smectic A, smectic C, nematic or cholesteric Liquid Crystals (LCD), Light Emissive Diodes (LED), Organic Light Emissive Diodes (OLED), Plasma Display Panels (PDP) or other technologies, may revolutionize the outdoor advertising market. According to forecasts by DisplaySearch, the 2002 USD 100 million OLED market, which may be the most promising of the emerging flat panel display technologies, is projected to grow to USD 2800 million by 2007, while Stanford Resources is projecting a USD 2300 million OLED flat panel market by 2008. These forecasts make OLED a viable contender to the total global Thin Film Transistor (TFT) LCD market of approximately USD 31000 million or 48% of the total electronic display market, which constituted about USD 64000 million, globally in 2002.

The display component alone of the global outdoor advertising market is for the year 2002 estimated to represent a potential of more than USD 2000 million.

As of 2002, the largest full colour LED video screen is the Nasdaq screen on Time Square. The size is 90′×120′ (1003 M²), featuring 198 million light-emitting diodes. The over 8200 panels that make up the sign allow for the display of one giant screen, or the simultaneous operation of eight different ones. The estimated price of the sign was in excess of USD 27 million, with an additional USD 2 million of annual rent to the building owner.

Simple wireless messaging or computer programmable display systems in general are trivial, both with respect to private, advertising and industry applications.

Some existing proprietary techniques address the question of electronic communication between advertiser and consumer:

German patent DE 199 43 549 discusses a personal information system applicable to a limited zone (room) with a mobile information terminal and a positioning device. A customer information server may transmit customer information to a display based on its position or location.

In WO 02 17285 an advertising system using radio communication between advertiser and customer is described. The system is based on a radio connection between the advertiser and the consumer. When the advertiser and the customer come within reach of each other, a communication path is established, enabling the transmission of an advertisement.

EP 0927985 describes a solution for motion detection and advertising. The advertisements will only be shown when a customer is near a screen. By recording the amount of time a customer exposes himself to various advertisements, a profile may be made of the customer. In this way advertisements may be targeted to the particular customer.

U.S. Pat. No. 6,390,376 describes an apparatus for providing targeted advertising in public areas. Individuals are targeted on the basis of communication with electronic cards in the possession of persons in the vicinity of a display device.

WO 9719429 describes a data communication receiver for displaying graphic messages in radio receivers. The radio receiver obtains a message and provides a graphic image from a database based on the received signal.

US patent application no. 20020116265 describes a local in-store media advertising system where the advertising content is provided from a content server, and a viewer sensor compiles the number of viewers in the vicinity of a display.

All these systems target individuals, are triggered by the presence of an individual, or simply relate to the number of individuals present.

U.S. Pat. No. 6,408,278 discloses an information display system for displaying still pictures or video, and the system comprises among other things a control unit that chooses display content in accordance with inter alia socio-economic or behavioural parameter values, that is with targeting of display content toward different groups of individuals. However, this previously known system uses only a camera to monitor demographic parameters, i.e. by processing of a monitor image of an audience in front of a display unit, in addition to demographic data obtained by active feedback from people near the display unit by using a computer attached to a communication network, typically Internet. The solution depends on such a network, because the whole system is controlled from a central computer.

However, there remains a need for improving this technology, both with regard to taking other parameter types into consideration, and with regard to autonomy and “intelligence” for the display systems. The present invention aims to fulfil such a need.

### BRIEF SUMMARY OF THE INVENTION

Thus, in accordance with the present invention there is provided a method for operating at least one information display unit, a control unit controlling duration of, and selection between, various still picture and video messages being displayed by the display unit, the control unit operating in accordance with at least one timing algorithm based on socio-economic and behavioural parameters, whereby the messages are selected, changed, prolonged, repeated and deleted dependent on values of the parameters. The method according to the invention is characterized in that at least one sensor mounted near the display unit delivers to the control unit which is an independent local control unit, signals representative of any of

a) at least one environmental parameter,

b) at least one behavioural parameter, and

c) at least one environmental parameter and at least one behavioural parameter, said at least one timing algorithm also being based on possible environmental parameters and being operative to provide display control on the basis of the signals, thereby to provide independent message control and to adapt message selection, change, duration and frequency to a current parameter situation.

Preferable embodiments of the method of the invention appear from the appended dependent claims 2-4.

In another aspect of the invention, there is provided an information display system comprising at least one information display unit, a control unit controlling duration of, and selection between, various still picture and video messages being displayed by the display unit, the control unit being equipped with at least one timing algorithm for selecting, changing, prolonging, repeating and deleting respective messages on the basis of currently valid socioeconomic and behavioural parameter values held in store by the control unit. The information display system according to the invention is characterized by at least one sensor mounted near the display unit to deliver to the control unit which is an independent local control unit, signals representative of any of

a) at least one environmental parameter,

b) at least one behavioural parameter, and

c) at least one environmental parameter and at least one behavioural parameter, said at least one timing algorithm also being based on possible environmental parameters and being operative to provide display control on the basis of the signals, thereby to provide independent message control and to adapt message selection, change, duration and frequency to a current parameter situation.

Favourable embodiments of the system of the invention appear from the appended dependent claims 6 and 7.

The present invention makes it possible to target socio-economic groups of individuals by an external body as a function of time and/or location(s), at the is same time as the message(s) or piece(s) of information may be programmed to vary or change due to feedback from traffic (behavioural) data and/or weather (environmental) conditions, socio-economics through research, with the additional possibility of real time interaction between transmitter and receiver.

### BRIEF DESCRIPTION OF DRAWINGS

In the following, a more detailed description of the invention will be given, with reference to preferred embodiments and to the appended drawings, in which

FIG. 1 depicts, in a schematic manner, the general layout of the system of the invention,

FIGS. 2 and 3 show typical arrangements of displays in environments where large groups of persons can be targeted, and

FIG. 4 shows a flowchart regarding the operation of the system of the invention.

### DETAILED DESCRIPTION

In a modern society, both in rural and urban areas, various demographic or socioeconomic groups, based on address, income, education, age, sex etc., will pass certain different public locations as a function of time. E.g. business commuters may tend to enter an urban area during early morning hours and leave the same spot in late afternoon and/or early evening. The same socioeconomic group may pass certain different locations during lunchtime.

The same spot or location(s) may be exposed to other demographic group(s) or people, e.g. to and from shopping during late morning hours or early afternoon. In the afternoon the very same location may be exposed to school children or students, and in the evening or at night the location may be exposed to (different) people going to movie theatres, restaurants, various events at an (sports) arena or field etc. From an advertisement point of view, a challenge is to target these various groups of people selectively and in a cost effective way, from the same locations or at various locations (in sequence) as a function of time, weekday, weather condition, traffic velocity, type of arrangement at a sports arena or field etc., with the additional possibility of real time interaction(s) or communication(s) between the advertiser and/or message(s) and receiver (consumer).

Research and statistical analysis may be required to obtain adequate basic time varying socioeconomic data as a function of location.

At the same time it would be beneficiary to vary the exposure time of each message or advertisement and/or the information/message itself, as a function of both regular and unscheduled pedestrian or vehicle velocity and/or density, due to ordinary rush hours or events and/or changing weather conditions or dB levels as a function of events at an (sports) arena or field.

In case of unscheduled traffic slow down due to road incidents, trafficers may absorb an increasing number of information spots as a function of time. Also, with changing weather conditions, say from rain to sunshine, it would be advantageous to change the advertising message to products associated with the specific type of real time weather or the noise/accumulated voice or dB level.

The solution to these challenges is to implement guidance and control of one or several electronic or programmable boards, displays or projection sites, with or without sequencing, to target various demographic groups as a function of time and/or location, while at the same time making the boards independent and intelligent by adding “behavioural” sensors to measure for instance real time vehicle or pedestrian density and/or velocity, or noise level, and “environmental” sensors to measure for instance weather parameters like temperature, humidity, light intensity and the like. This will, in addition to high volumes at low CPT, also include a higher concentration of main target groups among the receivers.

By sequencing several boards or displays, various messages may follow the consumer or trafficer as a function of real time velocity and/or location or noise or dB level.

This can be combined with real time interactions or communications between the transmitted message(s) and the receiver(s) [consumer(s)] for the transmission of additional information, like sound, music or enabling the ordering of goods or services related to the message(s), with billing routines.

In this way one may obtain profitability by optimising the exposure to the audience, and at the same time the transmitter (or advertiser) may gather valuable statistics and/or billing data.

Due to the relatively high cost per square unit associated with flat panel displays, combined with general profitability concerns, optimized applications are paramount in obtaining sound business economics by integrating these technologies as components in marketing or messaging systems, where socio-economic targeting in combination with behavioural and/or environmental sensors represent key elements in the operation of such systems. At the same time it is advantageous for these systems to allow for the communication and/or the interaction between the advertiser, advertisement(s) or message(s) and the receiver(s) by any wireless means, like bluetooth, telephone, wap telephone, internet (palm top) etc., in real time, allowing the receiver(s) the ability to gather further information about the advertisement(s) or message(s), sound or music, or to order the goods or services in question.

One embodiment of the present invention opens up the possibility for an intelligent and time varying display system.

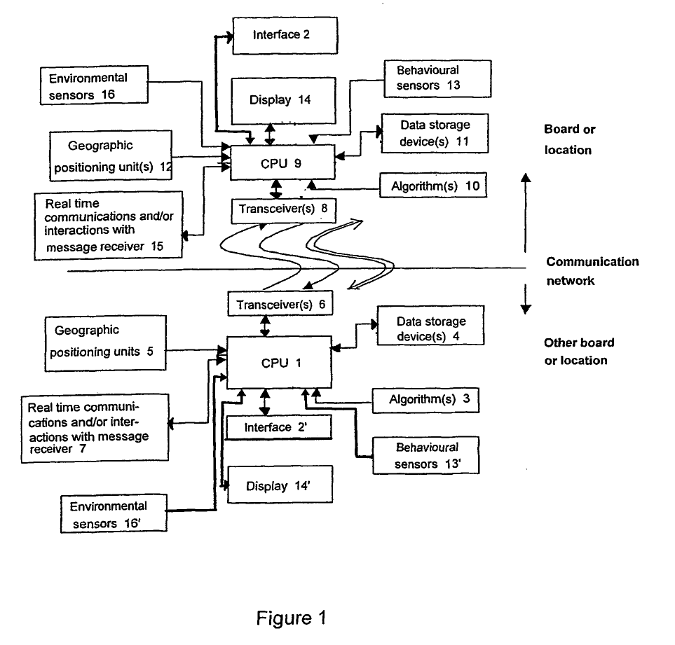

The present invention, with reference to FIG. 1, consists of a display system having at least one local display unit or screen 14 and a local processing unit (CPU) 9, with or without interconnection by cable or wireless communications to at least one similar system somewhere else, with a local screen 14′ and a local CPU 1. The CPU may have one or several analogue or digital data interfaces 2 with the capacity for the input of combinations of text, music, speech, graphics, video, motion pictures or any other means of audio or visual communications, from a marketing department or from an operating company.

The CPU 9/1 may be connected to a geographic positioning device 12/5, a data storage device 11/4 for the storage of combinations of text, music, speech, graphics, video, motion pictures or any other means of audio or visual communications and a real time communications unit 15/7 for the communications from and to the receiver (consumer) by e.g. telephone or the internet, enabling the ordering and billing of goods and services, providing further information or sound, in real time, according to the advertisements or messages shown at the board.

As an integral part of the CPU(s) is an algorithm or algorithms 10/3 which is/are characterised by its/their ability to;

Govern the interface between data input, data storage and geographic positioning.

Provide data as analogue or digital signals to and from transceivers.

Guidance and control of transmission and the receiving of analogue and/or digital signals to one or several electronic boards or displays or projector sites by cable or wireless communications.

Interaction with sensors.

Communications from and to the receiver (consumer).

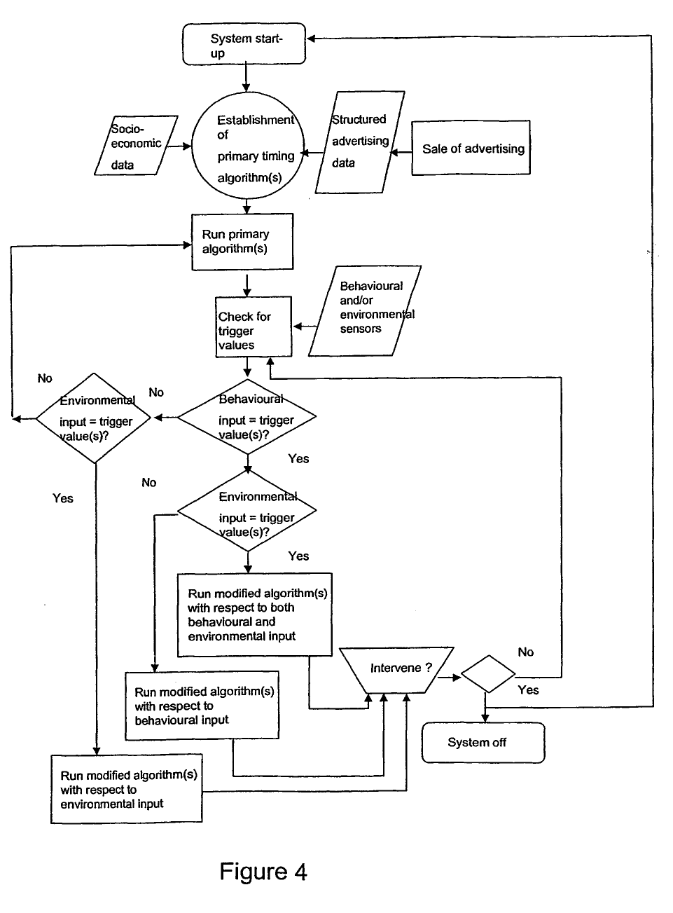

FIG. 4 provides a diagram of the interconnection (system) between socio-economic data, structured advertising spots and the primary timing algorithm(s). Furthermore, the figure outlines how the primary algorithm(s) are adjusted according to trigger values, based on input from various sensors. Based on socio-economic profiles of people passing a certain location as a function of time, weekday etc., market research and common sense, combined with actual advertising spots or messages that are (paid) to be displayed, a primary sequencing chain of the various advertisements is established. Adjusted version(s) of the primary sequencing of the various advertisements or special replacement (advertising) modules are established as a function of e.g. changes in velocity of passing cars, shifting weather conditions from e.g. sunshine to rain etc. Input from various sensors, based on defined trigger values and predetermined elements within the primary timing algorithm(s), will decide what replacement modules will be run, for how long etc.

There will always be the possibility to intervene manually with the system, update the primary sequencing chain and/or secondary or replacement modules through cable or wireless means, either locally or from anywhere in the world.

Transceivers 8/6 transmit and receive signals from and to the transceivers 6/8 at the location(s) of the boards, displays or projector sites. The display board or advertising unit is controlled by processor 9/1, which, in addition to the transceiver(s) 8/6, is/are connected to a geographic positioning unit(s) 12/5, on location data storage device(s) 11/4, behavioural sensors 13/13′, environmental sensors 16/16′, display(s) 14/14′, and there is a possibility for real time (wireless) communications by means of communication unit(s) 1517 using bluetooth, telephone, wap telephone, internet etc. The processing unit 9/1 is governed by an algorithm or algorithms 10/3 which is/are characterised by its/their ability to;

Provide and process data as analogue or digital signals to and from transceivers.

Govern the interaction between transceiver signals, data storage and geographic positioning.

Guidance and control of transmission and the receiving of analogue and/or digital signals to one or several electronic boards or displays or projector sites by cable or wireless communications with or without interactions with another CPU 1/9.

Provide confirmation signal(s) or message to transceiver 8/6 for transmission to transceiver 6/8 as input to CPU 1/9.

Change the message(s) or displayed image(s) due to input from real time feedback from various sensors, according to pre-programmed procedures, and be able to interact with one or several electronic boards or displays or projector sites by cable or wireless communications.

Handle the interaction with the message receiver, in real time, by telephone, bluetooth, internet or any other type of wireless communications.

The various communication protocols could be of standardised types.

The geographic positioning unit could be a standard GPS unit connected to the CPU by a standard GPS communication protocol. For e.g. Gamnin™ this can be done through the RS-232 serial communication port. For other GPS models the communication can be done in the NMEA 0183 protocol.

The various behavioural and environmental sensors 13, 16 could be of a variety of combinations, represented by commercial or non-commercial types, like infrared motion detectors, radars, humidity detectors, light intensity detectors, pressure detectors or gauges within the pavement of the road, lasers, microphones etc.

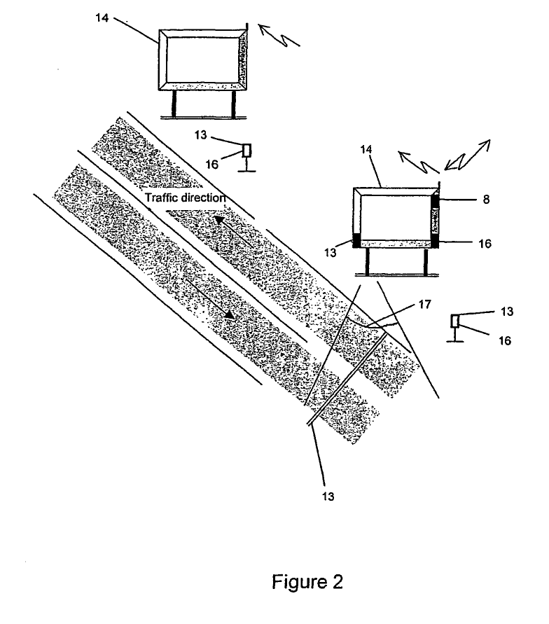

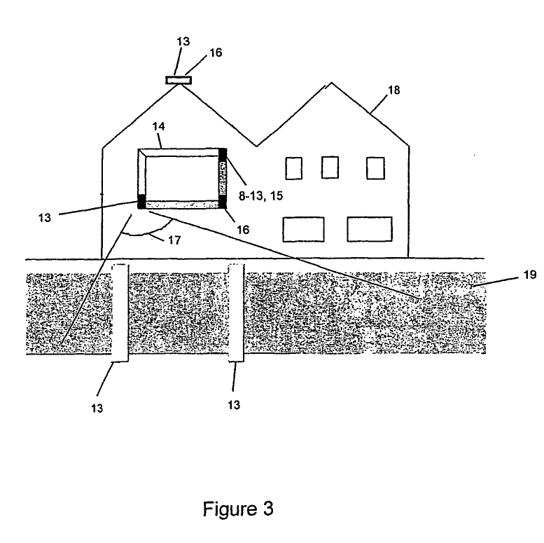

FIGS. 2 and 3 show the system in various applications. In FIG. 2 display units 14 are located at separate road sites. As examples, various behavioural sensors 13 and environmental sensors 16 are shown integrated in the framing of a display screen, or at an alternative location in the close vicinity of the screen, disregarding the specific type of sensor at the alternative position. A sector 17 for velocity measurements by means of a laser or radar sensor 13, and pressure gauges 13 (behavioural sensors, i.e. measuring traffic) within the pavement are also provided. The processing unit(s) 9/1 with algorithm(s) 10/3, transceivers 8/6, data storage 11/4, GPS 12/5, communication unit(s) 15/7 etc are (may be, but not necessarily) integrated within the display units 14.

In FIG. 3 an integrated display unit 14 for a more urban setting is provided. Sensors 13, 16 are shown as built-in in the framing of the display 14, or alternatively located on the roof of the building 18 in question, connected to processing unit 9 by wire or wireless means. A sector 17 for velocity and/or people density measurements and pressure measurements by means of pressure gauges 13 within the pavement (here an area 19 predominantly for pedestrians) are also offered. The processing unit 9 with algorithms 10, transceiver 8, data storage 11, GPS 12, communication unit 15 etc are (may be, but not necessarily) integrated within the display units 14.

The present invention is not limited to the described system and algorithms, in the sense that any generic variations of the system or devices, such as various arrangements or rearrangements of the various components, various sizes and geometric designs of components, independent and automatic control and guidance of components of the system, the placement of sensors or panels or any other components on movable fixtures, built in or partly or totally integrated systems or solutions, are all obvious variations to be derived by a skilled person in the art, subjected that this description of the stated invention is provided.

Subsequently, all devices or systems that are functionally equivalent will be included by the scope of this invention, and any modifications of the invention that lie within the scope of the stated claims. Based on the above statements, all drawings and figures are to be interpreted illustratively and not in a limiting context. It is further presupposed that all the claims shall be interpreted to cover all generic and specific characteristics of the invention which are described, and that all aspects related to the invention, no matter the specific use language, shall be included. Thus, the stated references have to be interpreted to be included as a part of this invention's basis, methodology, mode of operation and apparatus.

Important features of the invention are:

the guidance and control of one or several electronic or programmable boards, displays or projection sites,

targeting various demographic groups as a function of time, weekday, location, weather condition, traffic velocity, type of event,

the making of the boards independent and intelligent by adding sensors to measure vehicle or pedestrian density and/or velocity and weather parameters like temperature, humidity, light intensity, noise/dB level and the like,

sequencing several boards or displays, enabling various messages to follow the consumer or trafficer as a function of real time velocity, weather condition, preprogrammed sequence and the like,

real time interactions or communications with the receiver (consumer) for the transmission of additional information, sound, music or enabling the ordering of goods or services with billing,

the gathering of statistics and/or billing data.

Application areas of the information display system of the present invention may be at airports, railway stations, bus stations, underground stations, ferry terminals, or inside or outside shopping malls and stores, or in public places like sports arenas, market places, along highways and roads etc.

1. A method for operating at least one information display unit (14), a control unit (9) controlling duration of, and selection between, various still picture and video messages being displayed by said display unit (14), said control unit (9) operating in accordance with at least one timing algorithm based on socio-economic and behavioural parameters, whereby said messages are selected, changed, prolonged, repeated and deleted dependent on values of said parameters,
characterized in that at least one sensor (13, 16) mounted near said display unit (14) delivers to said control unit (9) which is an independent local control unit (9), signals representative of any of
a) at least one environmental parameter,
b) at least one behavioural parameter, and
c) at least one environmental parameter and at least one behavioural parameter, said at least one timing algorithm also being based on possible environmental parameters and being operative to provide display control on the basis of said signals, thereby to provide independent message control and to adapt message selection, change, duration and frequency to a current parameter situation.

2. The method of claim 1,
characterized in that said timing algorithm is based on statistical data regarding the visiting frequency of specific socioeconomic people groups in a viewing area of said display unit (14).

3. The method of claim 1,
characterized in that said independent control unit (9) acts in a signal transport network to modify said independent message control on the basis of information transferred via said network from other control units (1) attached to respective display units (14′), regarding their local parameter values.

4. The method of claim 1,
characterized in that sensors (13, 16) mounted near at least two display units (14, 14′) provide a basis for sequencing messages to be displayed in time dependency from one display unit (14) to the other (14′), said at least one timing algorithm being operative to interrelate behavioural and/or environmental parameter values detected at several display unit sites, respective control units (9, 1) attached to said display units (14, 14′) being interconnected via a communications network, for instance a telephone network or Internet.

5. An information display system comprising at least one information display unit (14), a control unit (9) controlling duration of, and selection between, various still picture and video messages being displayed by said display unit (14), said control unit (9) being equipped with at least one timing algorithm for selecting, changing, prolonging, repeating and deleting respective messages on the basis of currently valid socioeconomic and behavioural parameter values held in store by said control unit (9),
characterized by at least one sensor (13, 16) mounted near said display unit (14) to deliver to said control unit (9) which is an independent local control unit (9), signals representative of any of
a) at least one environmental parameter,
b) at least one behavioural parameter, and
c) at least one environmental parameter and at least one behavioural parameter, said at least one timing algorithm also being based on possible environmental parameters and being operative to provide display control on the basis of said signals, thereby to provide independent message control and to adapt message selection, change, duration and frequency to a current parameter situation.

6. The system of claim 5,
characterized in that said independent control unit (9) is a node in a signal transport network, thereby being able to modify said independent message control on the basis of information transferred via said network from other control units (1) attached to respective display units (14′) regarding their local parameter values.

7. The system of claim 5,
characterized by sensors (13, 16) mounted near at least two display units (14, 14′) to provide a basis for sequencing messages to be displayed in time dependency from one display unit (14) to the other (14′), said at least one timing algorithm being operative to interrelate behavioural and/or environmental parameter values detected at several display unit sites, respective control units (9, 1) attached to said display units (14, 14′) being interconnected via a communication network, for instance a telephone network or Internet.
